(19) United States
(12) Patent Application Publication
(10) Pub. No.: US 2026/0001211 A1
(43) Pub. Date: Jan. 1, 2026

(54) CLEANING ASSEMBLY WITH A DISPOSABLE CLEANING IMPLEMENT

(71) Applicant: THE CLOROX COMPANY, Oakland, CA (US)

(72) Inventors: Benjamin Ma, Pleasanton, CA (US); Jacob McMullen, Newark, CA (US)

(21) Appl. No.: 18/759,908

(22) Filed: Jun. 30, 2024

(51) Int. Cl. B25G 3/12; A47K 17/00

(52) U.S. Cl. CPC B25G 3/12; A47K 17/00

(57) ABSTRACT

A cleaning assembly can be manipulated by a user to clean difficult-to-reach surfaces, such as toilet bowl surfaces. The cleaning assembly includes an elongate member, which may have a handle portion that can be grasped by a user. The elongate member has a connector system to which a disposable cleaning implement can be releasably coupled. The disposable cleaning implement can be coupled to the connector system, used to clean one or more surfaces, and then decoupled from the connector system and replaced with another disposable cleaning implement.

### FIELD OF THE INVENTION

The present application relates to cleaning tools, and in particular, to a cleaning tool or cleaning assembly for a toilet that can be used with disposable cleaning implements that are replaceable.

### BACKGROUND

Due to heath and sanitation concerns, lavatory facilities, such as toilets and urinals, are routinely cleaned. Such cleansing not only precludes the spread of infections and diseases, but also prevents or reduces unpleasant odors in various facilities. Deodorizers and disinfectants are routinely applied to maintain a fresh and substantially germ-free environment.

Typically, special toilet bowl brushes and cleaning solutions are applied to various toilet surfaces. Generally, these cleaning devices include a handle with a brush head mounted to an end of the handle. These brush heads enable cleaning inside a toilet bowl. One undesirable task involves the cleaning of underside of the lip and rim portion of a toilet bowl. To reduce contact by a user with toilet surfaces, toilet brushes are often angled at the brush head which aids reaching such undersides of the rim. Moreover, containers for disinfecting and deodorizing solutions are also often angled to achieve delivery of cleaning solutions to the undersides of the rim.

Regardless of the chemical solutions applied, some amount of physical scrubbing with the brush is necessary to remove stains and deposits from the toilet bowl effectively. Thus, after disinfecting and deodorizing cleaning solutions have been applied, a toilet bowl brush is utilized to scrub the toilet bowl surfaces. While this cleaning approach is used to disinfect and clean, several inherent problems exist. For example, once the toilet bowl has been cleaned, the toilet brush is typically rinsed or allowed to drip dry before storage or further use. As a result, some of the infectious germs that may have been collected on the cleaning tool are likely to remain on the brush, and are likely to be transported along with the brush. Moreover, this cleaning arrangement is potentially dangerous in that the liquid disinfectants and deodorizers may pose serious health hazards.

Accordingly, there is a need for an improved cleaning tool that reduces, if not eliminates, the transmission of infectious germs from one location to another, as well as reduces the potential health hazards associated with liquid disinfectants and deodorizers.

### SUMMARY

In one aspect of the present disclosure, a cleaning assembly comprises an elongate member having a handle portion and a coupling portion, a connector system supported by the elongate member, the connector system including a gripping member and a release mechanism, the gripping member including spaced apart resilient fingers, the release mechanism being actuatable by a user to move the resilient fingers of the gripping member from securing positions to releasing positions, and a disposable cleaning implement mountable to the coupling portion of the elongate member via the connector system, the disposable cleaning implement includes a cleaning member, and a fitment coupled to the cleaning member, the fitment having a base, and a connector extending from the base, the connector having spaced apart curved engagement surfaces, each of the curved engagement surfaces terminating in an outwardly extending ridge, each outwardly extending ridge defining a receiving area beneath the outwardly extending ridge, each receiving area being separated from any adjacent receiving area, wherein as the disposable cleaning implement is engaged with the elongate member, each of the resilient fingers moves along one of the curved engagement surfaces, moves over one of the outwardly extending ridges, and is positioned in one of the receiving areas.

In one embodiment, each of the curved engagement surfaces is a concave surface.

In another embodiment, the fitment has three curved engagement surfaces, and each of the curved engagement surfaces is bounded on its sides by curved walls.

In an alternative embodiment, each curved engagement surface extends from a first side to a second side opposite the first side, and extends from a first end to a second end opposite the first end.

In another embodiment, for each curved engagement surface, its second end terminates in one of the outwardly extending ridges.

In an alternative embodiment, the curved walls of each of the curved engagement surfaces separate that curved engagement surface from adjacent curved engagement surfaces.

In another embodiment, each receiving area is defined by a first wall on a first side, a second wall on a second side, and one of the outwardly extending ridges.

In one embodiment, the disposable cleaning implement self-locates on the elongate member when each of the resilient fingers engages one of the receiving areas of the fitment, which prevents rotation of the disposable cleaning implement relative to the elongate member.

In another embodiment, each of the resilient fingers has as a distal end with an inwardly extending projecting portion with a convex configuration, and each inwardly extending projecting portion is inserted into one of the receiving areas of the fitment.

In an alternative embodiment, the fitment has three curved engagement surfaces and three receiving areas, the gripping member has three resilient fingers, and each of the three resilient fingers engages one of the three receiving areas when the disposable cleaning implement is coupled to the elongate member.

In another aspect of the present disclosure, a disposable cleaning implement that is mountable to an elongate member having a connector system, the connector system including a gripping mechanism and a release mechanism, the disposable cleaning implement comprises a cleaning member, and a fitment coupled to the cleaning member, the fitment having a base, and a connector extending from the base, the connector having a plurality of sloped engagement surfaces spaced apart from each other, each of the plurality of sloped engagement surfaces extending to an outwardly oriented ridge, each outwardly oriented ridge defining a receiving area beneath the outwardly oriented ridge, each receiving area being separated from adjacent receiving areas, wherein as the disposable cleaning implement is engaged with the gripping mechanism of the elongate member, resilient members of the gripping mechanism move along different ones of the plurality of sloped engagement surfaces, moves over one of the outwardly oriented ridges, and engages one of the receiving areas.

In one embodiment, each of the sloped engagement surfaces is a concave surface.

In another embodiment, the fitment has three sloped engagement surfaces, and each of the sloped engagement surfaces is bounded on its sides by curved walls.

In an alternative embodiment, each sloped engagement surface extends from a first side to a second side opposite its first side, and extends from a first end to a second end opposite its first end, the second end terminating at outwardly oriented ridge associated with the sloped engagement surface.

In yet another embodiment, each receiving area is defined by a first wall on a first side, a second wall on a second side, and one of the outwardly oriented ridges.

In another embodiment the disposable cleaning implement self-locates on the elongate member when each of the resilient members engages one of the receiving areas of the fitment, which prevents rotation of the disposable cleaning implement relative to the elongate member.

In an alternative embodiment, the fitment has three sloped engagement surfaces and three receiving areas, and each of the three receiving areas is aligned with one of the three sloped engagement surfaces.

In another aspect of the present disclosure, a disposable cleaning implement is mountable to an elongate member having a connector system, the connector system including a gripping mechanism and a release mechanism, the gripping mechanism having resilient members that are spaced apart from each other, the disposable cleaning implement comprises a cleaning member, and a fitment coupled to the cleaning member, the fitment having a base, and a connector extending from the base, the connector having a longitudinal axis, the connector having sloped engagement surfaces, outwardly extending ridges, and receiving areas, each sloped engagement surface is spaced apart from the other sloped engagement surfaces, each sloped engagement surface extends from a first end located a first distance from the longitudinal axis to a second end located a second distance from the longitudinal axis, the second distance being greater than the first distance and being located at one of the outwardly extending ridges, each outwardly extending ridge being located between one of the sloped engagement surface and one of the receiving areas, each receiving area being spaced apart from the other receiving areas, wherein as the disposable cleaning implement is engaged with the gripping mechanism of the elongate member, each resilient member moves along one of the sloped engagement surfaces, moves over one of the outwardly extending ridges, and engages one of the receiving areas.

In another embodiment, each of the sloped engagement surfaces is a concave surface, and each receiving area is defined by a first wall on a first side, a second wall on a second side, and one of the outwardly extending ridges.

In an alternative embodiment, the disposable cleaning implement self-locates on the elongate member when the resilient members engage the receiving areas of the fitment, which prevents rotation of the disposable cleaning implement relative to the elongate member . . .

### BRIEF DESCRIPTION OF THE FIGURES

To complete the description and in order to provide for a better understanding, a set of drawings is provided. The drawings form an integral part of the description and illustrate embodiments of the present application, which should not be interpreted as restricting the scope of the application. The drawings comprise the following figures:

FIG. 1 is a schematic block diagram of an embodiment of a cleaning assembly according to the present disclosure.

FIG. 2 is a schematic block diagram of another embodiment of a cleaning assembly according to the present disclosure.

FIG. 3 is a schematic block diagram of another embodiment of a cleaning assembly according to the present disclosure.

FIG. 4 is a perspective view of an embodiment of a cleaning assembly according to the present disclosure.

FIG. 5 is an exploded perspective view of certain components of the cleaning assembly illustrated in FIG. 4.

FIG. 6 is a perspective view of the gripping mechanism of the cleaning assembly illustrated in FIG. 4.

FIG. 7 is a different perspective view of the view of the gripping mechanism of the cleaning assembly illustrated in FIG. 4.

FIG. 8 is a side view of the gripping mechanism of the cleaning assembly illustrated in FIG. 4.

FIG. 9 is another perspective view of the gripping mechanism of the cleaning assembly illustrated in FIG. 4.

FIG. 10 is a perspective view of the fitment of the cleaning assembly illustrated in FIG. 4.

FIG. 11 is a side view of the gripping mechanism of the cleaning assembly illustrated in FIG. 4.

FIG. 12 is an end view of the gripping mechanism of the cleaning assembly illustrated in FIG. 4.

FIG. 13 is a perspective view of components of another embodiment of a cleaning assembly according to the present disclosure.

FIG. 14 is a side view of the components illustrated in FIG. 13.

FIG. 15 is a perspective view of components of another embodiment of a cleaning assembly according to the present disclosure.

FIG. 16 is a perspective view of components of another embodiment of a cleaning assembly according to the present disclosure.

Like reference numerals have been used to identify like elements throughout this disclosure.

### DETAILED DESCRIPTION

The following description is not to be taken in a limiting sense, but is given solely for the purpose of describing the broad principles of the present application. Embodiments of the present application will be described by way of example, with reference to the above-mentioned drawings showing elements and results of such embodiments.

The present disclosure relates to a cleaning assembly, such as a cleaning assembly that includes a disposable cleaning element with a triangular toilet wand pad fitment with sloped edges that enable the pad to self-orient and lock into place in an opening of a toilet wand. In one implementation, the fitment opens up a collet where each prong on the collet is sloped in a manner that helps with alignment to insert and as well as locking features prevent the fitment from being releasing unintentionally.

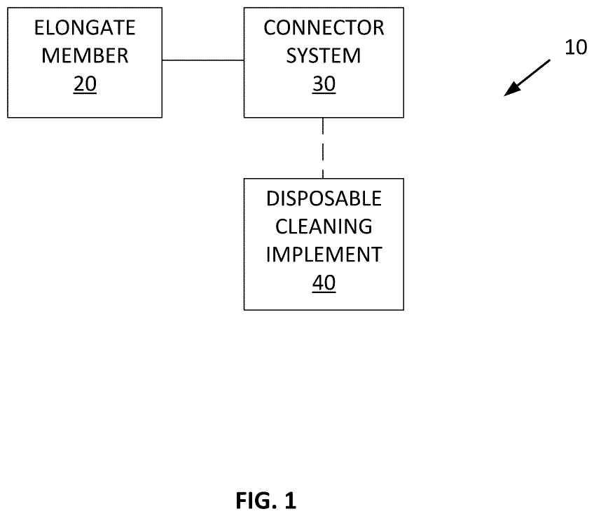

In one implementation of a cleaning assembly according to the present disclosure is illustrated in the schematic block diagram illustrated in FIG. 1. As shown, the cleaning assembly 10 can be manipulated by a user to clean difficult-to-reach surfaces, such as toilet bowl surfaces. The cleaning assembly 10 includes an elongate member 20, which may have a handle portion that can be grasped by a user. The elongate member 20 has a connector system 30 to which a disposable cleaning implement 40 can be releasably coupled. The disposable cleaning implement 40 can be coupled to the connector system 30, used to clean one or more surfaces, and then decoupled from the connector system 30 and replaced with another disposable cleaning implement 40.

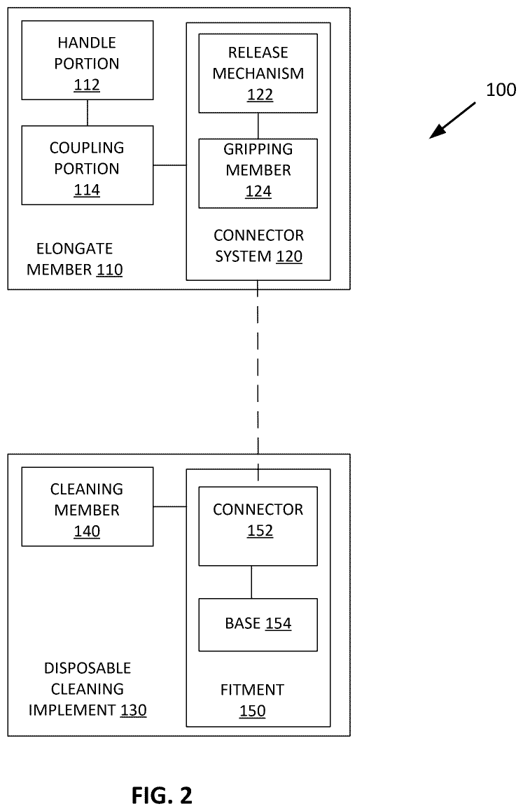

Turning to FIG. 2, a schematic block diagram showing another embodiment of a cleaning assembly according to the present disclosure is shown. Cleaning assembly 100 includes an elongate member 110 and a disposable cleaning implement 130 that is releasably coupled to the elongate member 110. In this embodiment, the elongate member 110 includes a handle portion 112, a coupling portion 114, and a connector system 120 to which the disposable cleaning implement 130 is coupled. The connector system 120 includes a release mechanism 122 and a gripping member 124. The gripping member 124 can grasp a portion of the disposable cleaning implement 130 to couple it to the elongate member 110. The release mechanism 122 can be manipulated by a user to reconfigure the gripping member 124 from a secured position to a released position, which results in the releasing of the disposable cleaning implement 130.

The disposable cleaning implement 130 includes a fitment 150 that has a base 154 and a connector 152 extending from the base 154. A portion of the connector 152 is grasped by the gripping member 124 of the elongate member 110. Coupled to the base 154 is a cleaning member 140, which is the portion of the cleaning assembly 100 that engages the surface.

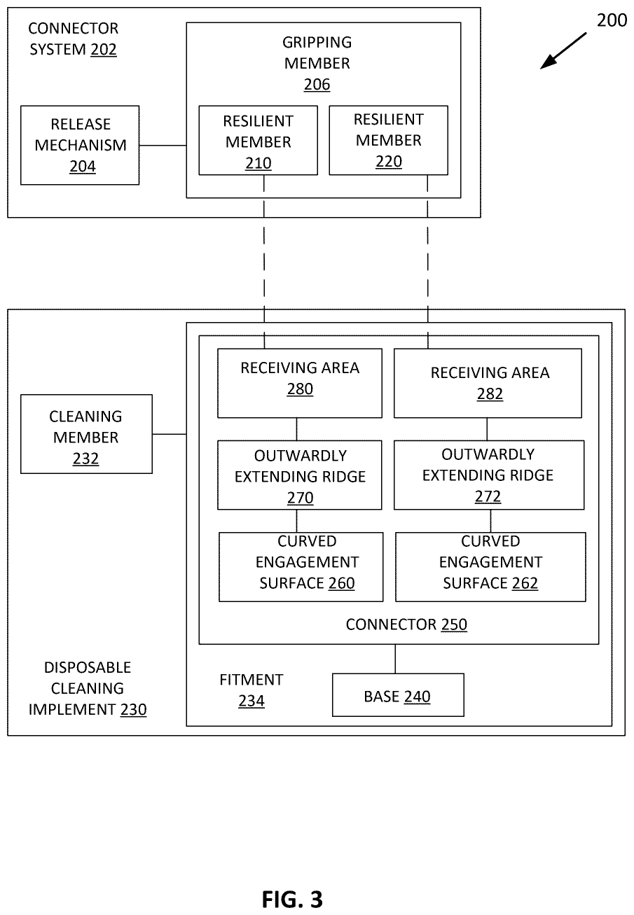

Referring to FIG. 3, another schematic block diagram showing another embodiment of a cleaning assembly is shown. Cleaning assembly 200 includes a connector system 202, which is supported by an elongate member. Cleaning assembly 200 also includes a disposable cleaning implement 230 that is coupleable to the connector system 202. In this embodiment, the connector system 202 has a gripping member 206 and a release mechanism 204 that can be actuated to manipulate the gripping member 206 so that it releases the disposable cleaning implement 230. The release mechanism 204 may include a slidable rod that can be moved between a locked position and a released position by a user. The gripping member 206 includes multiple resilient members 210 and 220 which, in this implementation, are movable independent of each other between holding positions and released positions.

The disposable cleaning implement 230 has a fitment 234 to which a cleaning member 232 is mounted. The fitment 234 is engageable by the gripping member 206 so that the gripping member 206 grasps part of the fitment 234. The fitment 234 includes a base 240 and a connector 250 extending from the base 240. In one implementation, the cleaning member 232 is mounted to the base 240 of the fitment 234.

The connector 250 includes multiple sets of features that are engageable by the resilient members 210 and 220 of the gripping member 206. The connector 250 includes a pair of curved engagement surfaces 260 and 262 that are spaced apart from each other. The curved engagement surfaces 260 and 262 can be referred to alternatively as sloped engagement surfaces. Curved engagement surface 260 ends in an outwardly extending ridge 270, which in turn separates the curved engagement surface 260 from a receiving area 280. Similarly, curved engagement surface 262 ends in another outwardly extending ridge 272, which in turn separates the curved engagement surface 262 from another receiving area 282. The outwardly extending ridges 270 and 272 are separate from each other, and the receiving areas 280 and 282 are separate from each other.

To mount the disposable cleaning implement 230 to the connector system 202, the gripping member 206 is positioned proximate to the fitment 234 and then is moved into engagement with the connector system 202. As the fitment 234 engages the gripping member 206, resilient member 210 engages curved engagement surface 260 and resilient member 220 engages curved engagement surface 262. The sloped or curved engagement surfaces 260 and 262 are configured so that the resilient members 210 and 220 are guided toward the middle of the engagement surfaces 260 and 262 as the resilient members 210 and 220 are moved along the engagement surfaces 260 and 262.

As resilient member 210 moves to an end of engagement surface 260, it engages outwardly extending ridge 270. As the fitment 234 is moved further toward gripping member 206, resilient member 210 moves over the outwardly extending ridge 270 and into engagement with receiving area 280. As mentioned above, the outwardly extending ridge 270 is located between engagement surface 260 and receiving area 280.

Similarly, as resilient member 220 moves to an end of engagement surface 262, it engages outwardly extending ridge 272. As the fitment 234 is moved further toward gripping member 206, resilient member 220 moves over the outwardly extending ridge 272 and into engagement with receiving area 282. As mentioned above, the outwardly extending ridge 272 is located between engagement surface 262 and receiving area 282.

When the resilient members 210 and 220 are engaged with receiving areas 280 and 282, respectively, the gripping member 206 is prevented from rotating about the connector 250 of the fitment 234, which provides stability to the cleaning assembly 200.

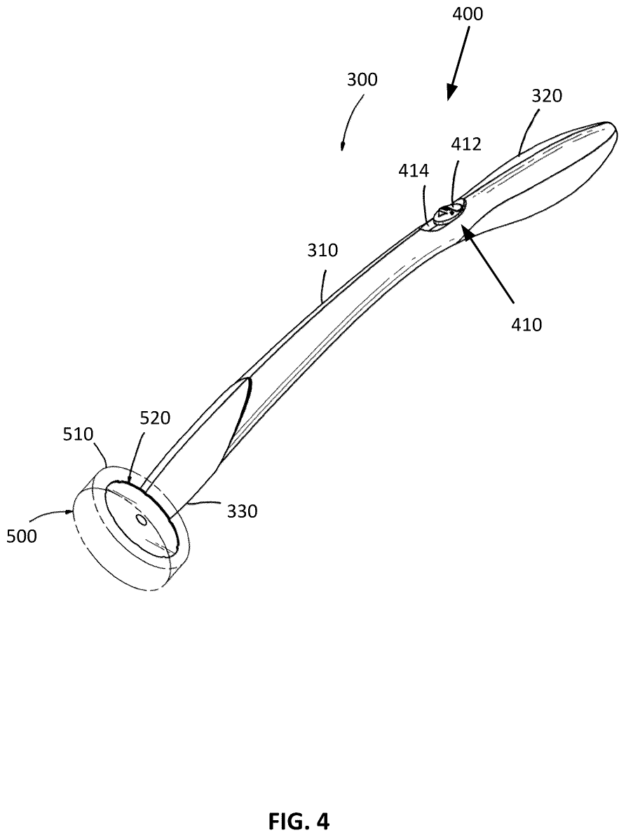

Turning to FIG. 4, a perspective view of an embodiment of a cleaning assembly according to the present disclosure is illustrated. In this embodiment, cleaning assembly 300 includes an elongate member 310 with a handle portion 320 and a coupling portion 330. The handle portion 320 can be grasped by a user to maneuver the elongate member 310 as desired.

A disposable cleaning element 500 is shown coupled to the elongate member 310. In this implementation, the disposable cleaning element 500 includes a cleaning member 510 (shown in phantom) and a fitment 520 to which the cleaning member 510 is mounted. The cleaning member 510 may be a pad or scrubbing pad that may contain a cleaning composition or to which a cleaning composition may be added. The cleaning pad may have a variety of different shapes or colors, including but not limited to, circle, square, hexagon, octagon, diamond, etc. The cleaning pad may have different layers of material that may contain dyes or colorants. The cleaning pad may also contain abrasive materials or particles or other additives to make the pad more resilient and to aid in the cleaning efficacy of the pad on hard to clean hard water stains and mineral deposits. In one embodiment, the cleaning composition is a sanitizing or disinfecting composition. The disposable cleaning element 500 is releasably connectable to the coupling portion 330.

The cleaning assembly 300 has a release mechanism 400 that is supported by the elongate member 310. The release mechanism 400 includes a release device 410 that can be manipulated by a user to release the disposable cleaning element 500 from the elongate member 310. The release device 410 includes a slidable rod mounted in the elongate member 310 and a slide switch 412 that is movable along a guide track 414 formed in the elongate member 310.

An exemplary cleaning assembly with a disposable cleaning element is disclosed in U.S. Pat. Nos. 7,386,910; 7,603,739; 8,286,295; and 9,021,649, and in U.S. Patent Publication App. No. 2014/0157535. The disclosure of each of those four U.S. patents and the U.S. patent publication is incorporated herein by reference in its entirety.

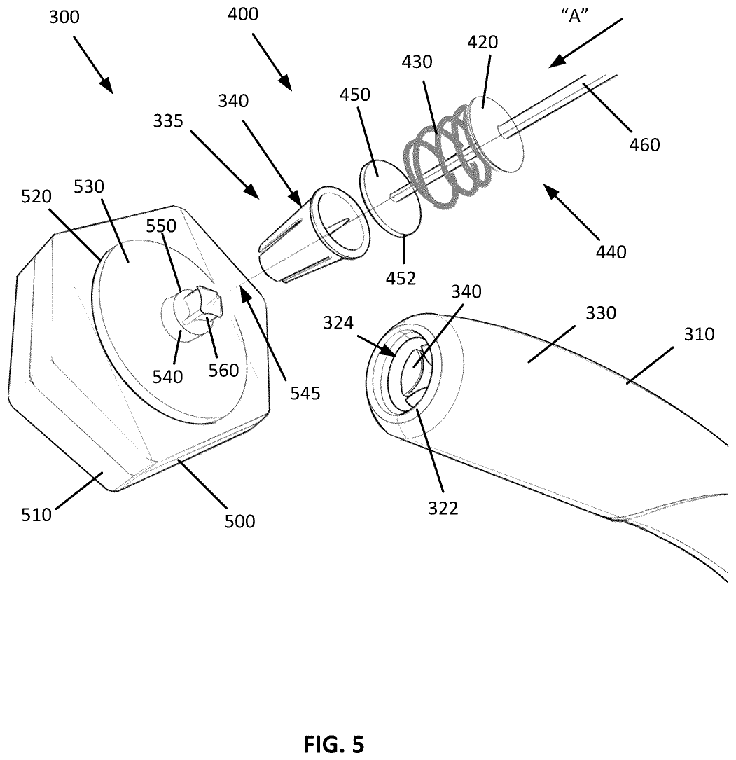

Turning to FIG. 5, an exploded perspective view of several components of an embodiment of a cleaning assembly according to the present disclosure is illustrated. In FIG. 5, a perspective view of an end of an elongate member 310 is shown. The coupling portion 330 of the elongate member 310 has a distal implement attachment end 322 that defines an opening 324 that is in communication with a cavity or chamber in the elongate member 310. A gripping mechanism or gripping member 340, which is described in detail below, is located in the cavity of the elongate member 310.

Some components of a connector system 335 are illustrated in FIG. 5, which include the gripping member 340. An embodiment of a disposable cleaning element is also shown. Disposable cleaning element 500 includes a cleaning member 510 that is mounted to a fitment 520. While fitment 520 is shown with a circular perimeter, in different implementations, the fitment 520 may have a differently shaped perimeter, such as an oval, hexagon, octagon, triangle, diamond, square, etc. The fitment 520 includes a base member or back plate 530 that has a connector or post 540 extending therefrom. The connector 540 has a body portion 550 and a coupling portion 560 at one end of the body portion 550. The coupling portion 560 is configured to be engaged by and secured to the gripping member 340 to mount the disposable cleaning element 500 to the elongate member 310.

Several other components of the release mechanism 400 are illustrated in FIG. 5. Release mechanism 400 includes a plunger mechanism 440 that has a plunger head 450 mounted at one end of a pushrod 460. Also, mounted to the pushrod 460 is a spring retainer plate 420 that engages a biasing device 430, which in this implementation is a coiled compression spring.

The plunger head 450 has a cam surface 452, which is located on the perimeter of the plunger head 450. The plunger head 450 is located in a cavity or receptacle defined by the gripping member 340. As the plunger head 450 is moved in the cavity of the gripping member 340, the cam surface 452 slides along the inner surfaces of the gripping member 340. As the pushrod 460 moves along the direction of arrow “A”, cam surface 452 moves along the inner surfaces of the gripping member 340, which forces the resilient members of the gripping member 340 to move outwardly, as described below. The resilient members are biased into securing or locking positions in which the resilient members engage the coupling portion 560. As the resilient members move outwardly to releasing or unlocking positions, the resilient members disengage from the coupling portion 560, which enables the removal of the disposable cleaning element 500 from gripping member 340.

The gripping member 340 is a triangular-shaped mechanism that has low complexity. As described in detail below, the configuration of the gripping member 340 enables it to auto-align as it is pushed into engagement with the connector 540 of the fitment 520. The coupling portion 560 is configured to prevent rotation of the disposable cleaning element 500 relative to the elongate member 310, which improves cleaning.

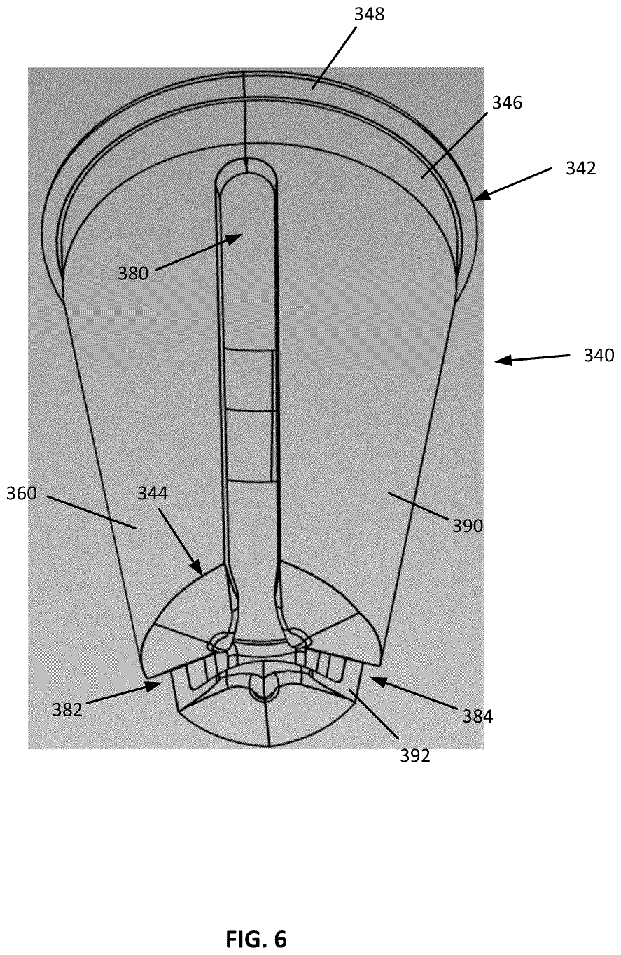

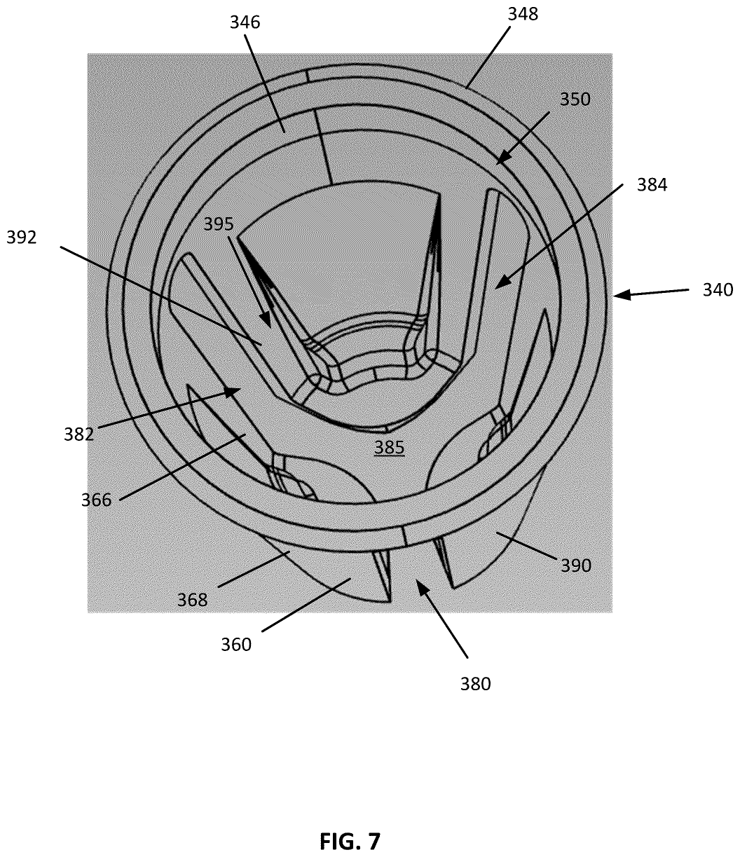

Turning to FIGS. 6 to 9, an embodiment of a gripping member 340 according to the present disclosure is illustrated. Initially turning to FIG. 6, the gripping member 340 has opposite ends 342 and 344, which can be referred to as a proximal end 342 and a distal end 344. The gripping member 340 includes a base portion 346 and three resilient fingers or members 360, 390, and 392 that are coupled to the base portion 346. The gripping member 340 may be made of a single integrally molded part or it may be made of separate components that are joined together. The base portion 346 has a rim 348 that extends around the perimeter of the base portion 346 at end 342. The three resilient members 360, 390, and 392 that extend from the base portion 346 and that are separated or spaced apart from each other. In this implementation, a gap or slot 380 is located between resilient members 360 and 390. Similarly, another gap or slot 382 is located between resilient members 360 and 392. Also, a third gap or slot 384 is located between resilient members 390 and 392. Resilient member 360 is described in detail below relative to FIGS. 7-9. It is to be understood that resilient members 390 and 392 have similar features to those of resilient member 360 that are described below.

While FIG. 6 is a perspective view of end 344, turning to FIG. 7, a perspective view of end 342 is illustrated. The base portion 346 defines an opening 350 that is in communication with a receptacle 395 that is defined by the resilient members 360, 390, and 392. The gaps or slots 380, 382, and 384 between the resilient members 360, 390, and 392 extend to a common central area or opening 385 at the end 344 of the gripping member 340. The slots 380, and 382, and 384 enable the resilient members 360, 390, and 392 to move relative to the base portion 346 independently of each other. Thus, when resilient members 360, 390, and 392 engage the coupling portion 560 of the connector 540, the resilient members 360, 390, and 392 are moved by the different surfaces of the coupling portion 560 and collectively align the gripping member 340 on the connector 540.

The resilient member 360 includes an inner surface 366 and an outer surface 368 that is opposite the inner surface 366. The inner surface 366 is engaged by the cam surface 452 of plunger head 450 when the release mechanism 400 is actuated.

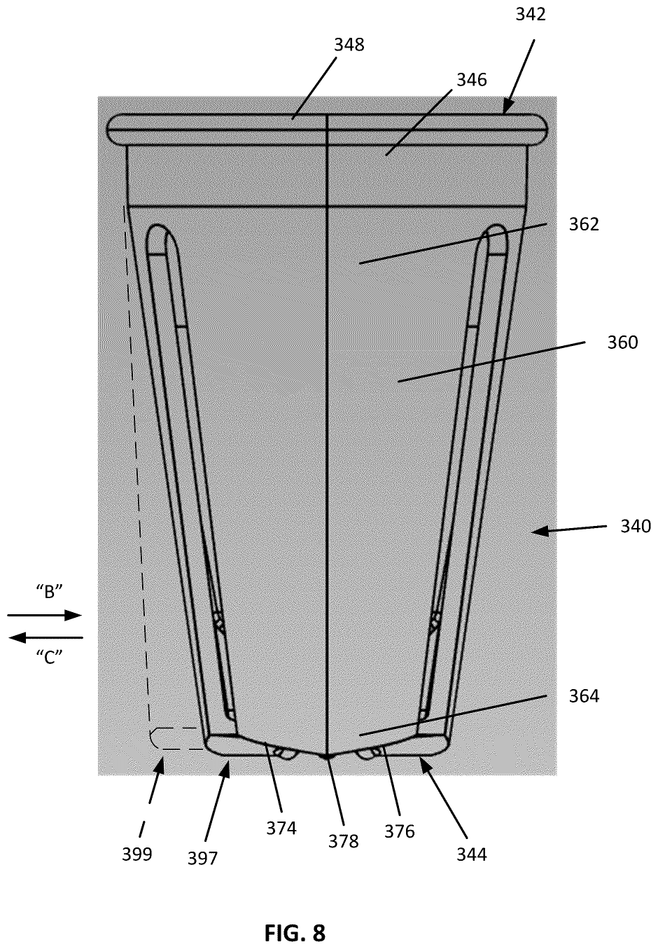

Turning to FIG. 8, a side view of the gripping member 340 is illustrated. The proximal end 342 and the opposite distal end 344 are shown, with the rim 348 extending from the base portion 346 near the proximal end 342. Resilient member 360 extending from the base portion 346 has a first end 362 proximate to the base portion 346 and a second end 364 opposite to the first end 362. First end 362 and second end 364 can be referred to alternatively as proximal end 362 and distal end 364, respectively. End 364 of resilient member 360 includes a pair of angled surfaces 374 and 376 that have a ridge or line 378 therebetween.

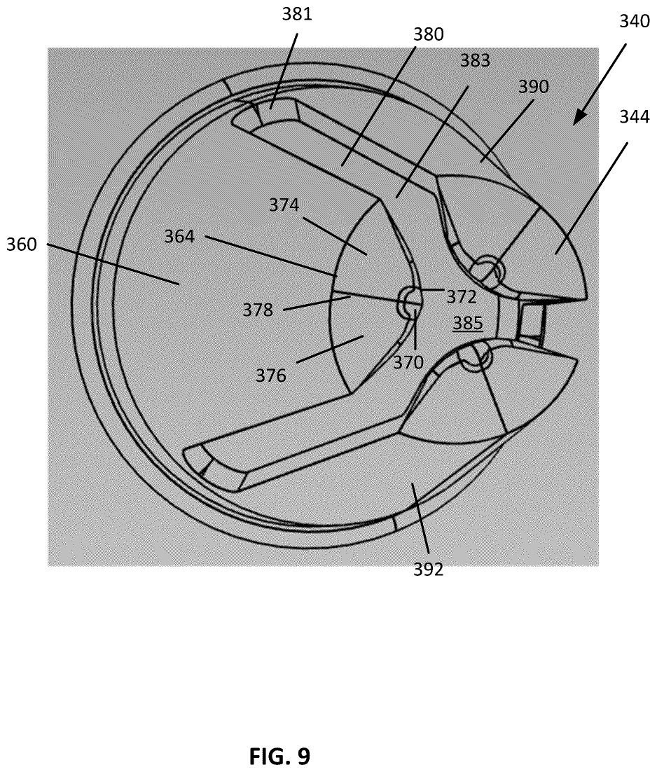

Referring to FIG. 9, another perspective view of end 344 of gripping member 340 is shown. Slot 380 has a first end 381, which is closed and is located near base portion 346, and an opposite second end 383, which is open and in communication with central opening 385. Slots 382 and 384 are structured similar to slot 380. The angled surfaces 374 and 376 and the ridge or line 378 located therebetween at end 364 of resilient member 360 are shown. End 364 includes an inwardly extending portion 370, which includes the angled surfaces 374 and 376. The inwardly extending portion 370 is oriented toward central opening 385 and has a convex configuration. In particular, the inwardly extending portion 370 has a convex curved end surface 372, which can be referred to alternatively as a convex end surface. When resilient member 360 engages the coupling portion 560 of the connector 540, the inwardly extending portion 370, and in particular, the convex curved end surface 372, engage different surfaces of the coupling portion 560, as described in greater detail below. Each of the other resilient members 390 and 392 has an inwardly extending portion and a convex curved end surface that are similar to the inwardly extending portion 370 and the convex curved end surface 372 of resilient member 360.

Each of the resilient members 360, 390, and 392 has a securing or unbiased position in which the resilient member extends from the base portion 346, as illustrated in FIGS. 6-9. However, when a force is applied to the inwardly extending portion of one of the resilient members 360, 390, and 392, that resilient member is moved outwardly away from the central opening 385 and away from the other resilient members to a releasing position or biased position.

Turning to FIG. 8, resilient member 360 is movable between a securing or unbiased position 397 a releasing position or biased position 399. Resilient member 360 is normally oriented in its unbiased position 397. When an outwardly directed force is applied to the inwardly extending portion 370 of resilient member 360, the resilient member 360 moves along the direction of arrow “C” from unbiased position 397 to biased position 399. When the force along the direction of arrow “C” is no longer applied to resilient member 360, resilient member 360 returns along the direction of arrow “B” from biased position 399 to unbiased position 397.

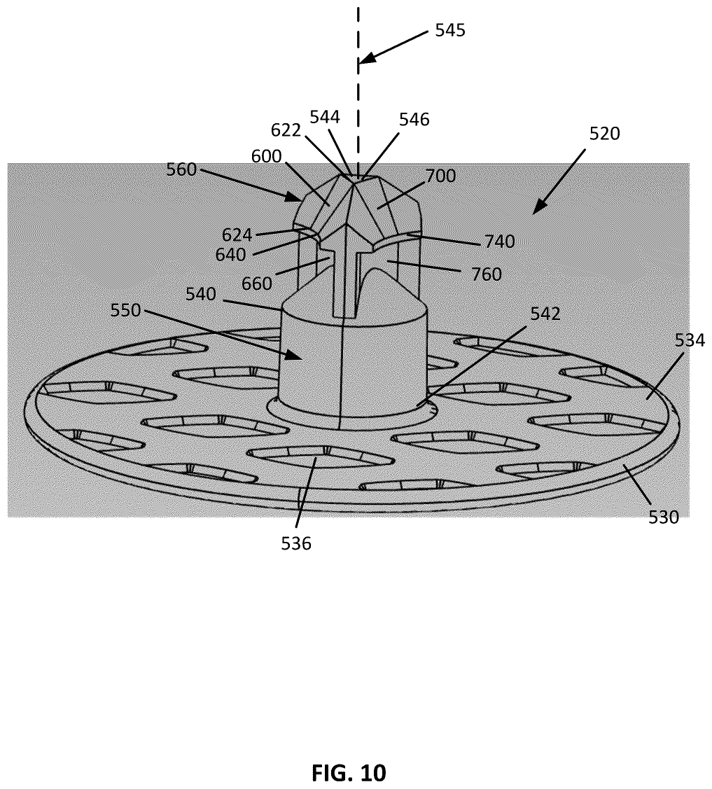

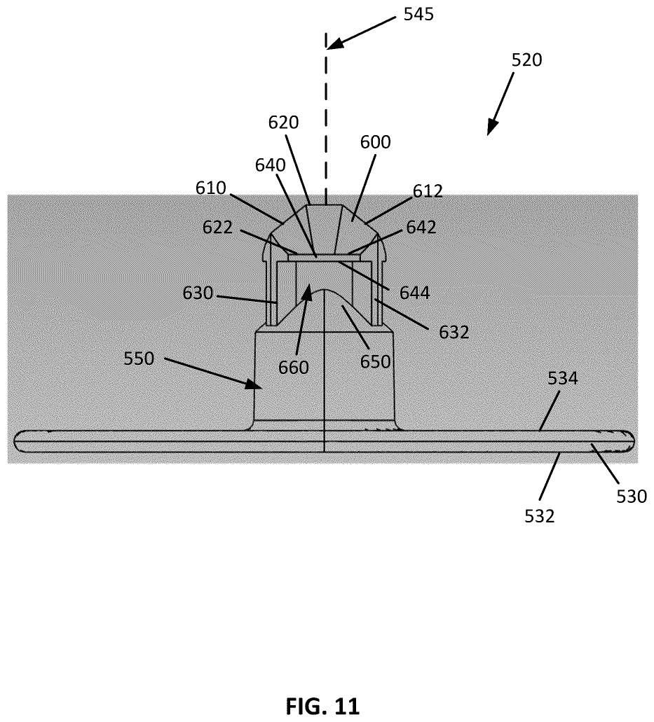

Turning now to FIGS. 10-12, different views of an embodiment of a fitment for disposable cleaning element 500 is illustrated. Fitment 520 includes a base member 530 that has opposite surfaces 532 and 534 (see FIGS. 10 and 11). Cleaning member 510 (discussed above) is coupled to surface 532 of base member 530. Surface 534 of base member 530 has several recesses 536 formed therein. In this implementation, the recesses 536 are specifically shaped in the form of a diamond that corresponds in part to the logo for CLOROX® branded products. In an alternative embodiment, there may be a single recess or multiple recesses and the shape of the recesses may be a variety of different shapes, letters or logos, including but not limited to, circles, squares, rectangles, etc.

Extending from the base member 530 is connector or post 540 that has an end 542 proximal to the base member 530 and an opposite end 544 that is distal relative to the base member 530. End 544, which can be referred to as a distal end 544 of connector 540, has an end surface 546. The connector 540 has a longitudinal axis 545 that extends through the connector 540.

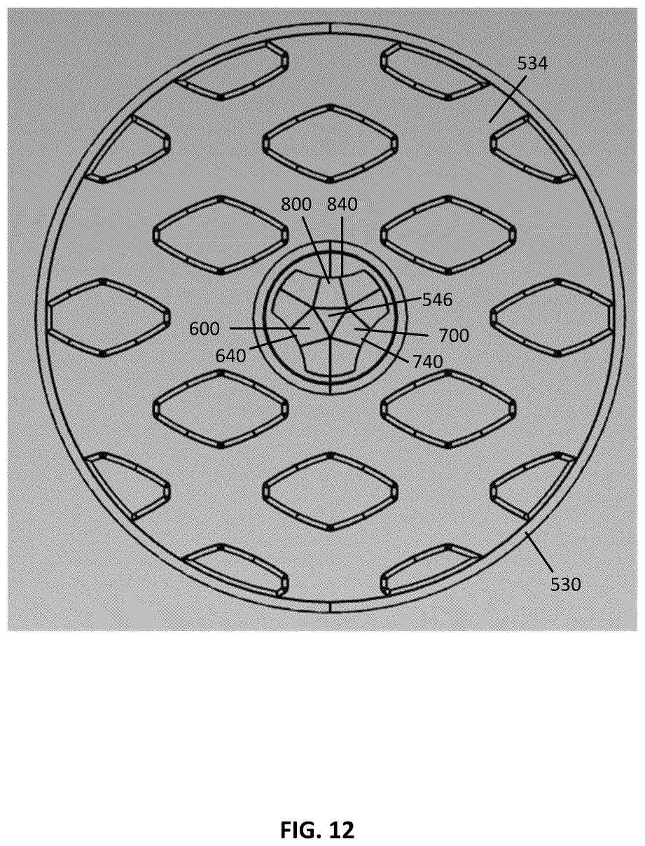

Referring to FIG. 12, a top view of the fitment 520 is illustrated which shows the end surface 546 of the connector 540 and the spaced apart curved engagement surfaces 600, 700, and 800. The curved engagement surfaces 600, 700, and 800 can be referred to alternatively as sloped engagement surfaces. Each of the curved engagement surfaces 600, 700, and 800 is a concave surface that extends at one end from the end surface 546 to an opposite end at one of the outwardly extending ridges 640, 740, and 840, respectively. The ridges 640, 740, and 840 can be referred to alternatively as outwardly oriented ridges.

Turning back to FIGS. 10 and 11, two of the three curved engagement surfaces, namely curved engagement surfaces 600 and 700 are illustrated. It is to be understood that the features of the three curved engagement surfaces 600, 700, and 800 are the same as each other. Accordingly, only curved engagement surface 600 is described in greater detail below.

Referring to FIG. 11, curved engagement surface 600 extends laterally from a first side 610 to a second side 612 opposite first side 610. Each of the first side 610 and the second side 612 is an angled side edge. Curved engagement surface 600 also extends vertically from a first end 620 that is adjacent to end surface 546 to a second end 622 that is adjacent to and forms part of outwardly extending ridge 640. Outwardly extending ridge 640 has an upper edge 642 and an opposite lower edge 644. Beneath the lower edge 644 is a receiving area 660 that is defined by the lower edge 644 and a curved surface 650 of the body portion 550, as well as by opposing curved walls 630 and 632.

Turning back to FIG. 10, the first end 622 of curved engagement surface 600 is located at a first distance relative to longitudinal axis 545, and the opposite second end 624 of curved engagement surface 600 is located at a second distance relative to longitudinal axis 545. Due to the sloped or curved configuration of curved engagement surface 600 from first end 622 to second end 624, the second distance is larger or greater than the first distance. In other words, the second end 624 is farther from the longitudinal axis 545 than the first end 622 is from the longitudinal axis 545. This curved or sloped shape to the curved engagement surface 600 applies a force on resilient member 360 as described below to move the resilient member 360 from its inward unbiased position 397 to its outward biased position 399.

When resilient member 360 engages connector 540, the convex end surface 372 of the inwardly extending portion 370 of the resilient member 360 contacts curved engagement surface 600 and moves along a direction from first end 620 toward second end 622. As resilient member 360 moves to second end 622, it engages the outwardly extending ridge 640, which biases the resilient member 360 from its unbiased position 397 to its biased position 399. As the convex end surface 372 of the resilient member 360 clears the outwardly extending ridge 640, the convex end surface 372 engages and is positioned in the receiving area 660 beneath the outwardly extending ridge 640. In addition, once the ridge 640 is cleared, the resilient member 360 returns to its unbiased position 397, and the resilient member 360 is coupled to the connector 540 because the inwardly extending portion 370 is located in the receiving area 660.

Resilient members 390 and 392 function in a similar manner when the fitment 520 and the gripping member 340 are moved into engagement with each other to couple the disposable cleaning element 500 to the elongate member 310. The convex end surfaces of the inwardly extending portions of the resilient members 390 and 392 move along curved engagement surfaces 600 and 700, over ridges 640 and 740, and into engagement with receiving areas (only receiving area 760 is shown in FIG. 10), respectively. Once each of the resilient members 360, 390, and 392 is engaged with one of the receiving areas on the connector 540, the disposable cleaning element 500 is coupled to the elongate member 310 and does not rotate relative to the elongate member 310 about axis 545. This anti-rotation feature of the coupling of the disposable cleaning element 500 to the elongate member 310 improves the control of the disposable cleaning element 500 and, as a result, the ability to clean using the cleaning assembly 300 because a variety of surfaces with different orientations and configurations can be reached more easily.

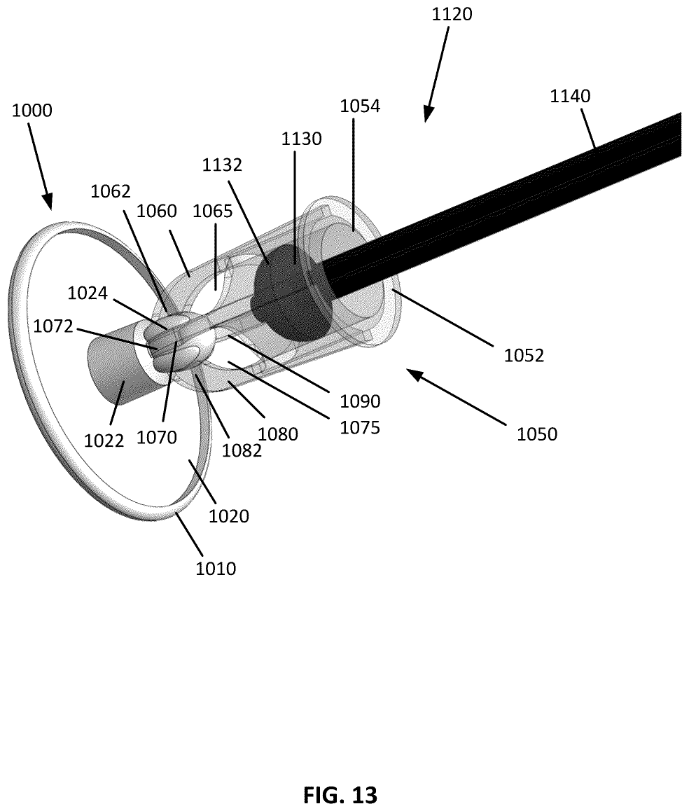

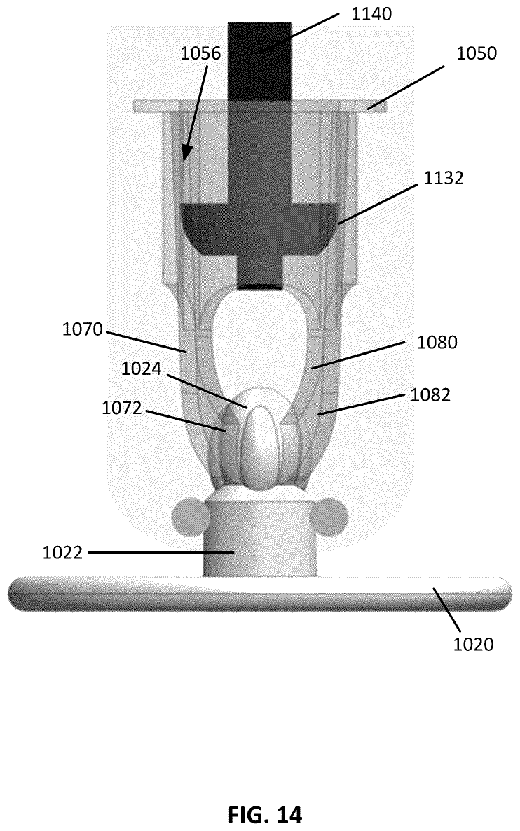

Referring to FIGS. 13 and 14, another embodiment of a cleaning assembly according to the present disclosure is illustrated. In this embodiment, the cleaning assembly includes a disposable cleaning element 1000 that has a fitment 1010 to which a cleaning element (not shown) is coupled. The fitment 1010 includes a base 1020 that has a connector 1022 extending therefrom, and which has a coupling portion 1024 that is used to couple the disposable cleaning element 1000 to an elongate member.

The elongate member has a gripping member 1050 that engages the coupling portion 1024 of the connector 1022 to couple the fitment 1010 to the elongate member. The gripping member 1050 includes a base portion 1052 that defines an opening 1054 and that has an inner surface 1056. In this embodiment, the gripping member 1050 has four spaced apart resilient members 1060, 1070, 1080, and 1090 that engage the coupling portion 1024 of the connector 1022. The resilient members 1060, 1070, 1080, and 1090 are separated or spaced apart by gaps or slots, such as gaps or slots 1065 and 1075. Each of the resilient members 1060, 1070, 1080, and 1090 includes an inwardly extending portion that engages the coupling portion 1024. Notably, only three of the inwardly extending portions 1062, 1072, and 1082 are illustrated.

In this embodiment, a release device 1120 is engageable with the gripping member 1050 to move the resilient members 1060, 1070, 1080, and 1090 outwardly and out of engagement with the coupling portion 1024. The release device 1120 includes a plunger head 1130 that is mounted on a pushrod 1140. The plunger head 1130 has an outer cam surface 1132 that engages the inner surfaces of the resilient members 1060, 1070, 1080, and 1090 to move them outwardly.

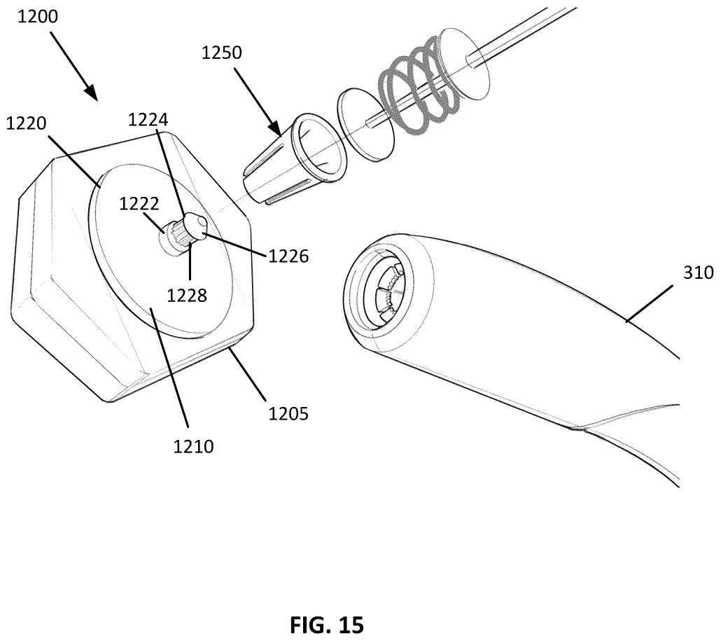

Turning to FIG. 15, some components of an alternative embodiment of a cleaning assembly according to the present disclosure are illustrated. In this embodiment, the cleaning assembly includes a disposable cleaning element 1200 that has a cleaning element 1205 mounted to a fitment 1210. The fitment 1210 has a base 1220 and a connector 1222 extending away from the base 1220. The connector 1222 has a coupling portion 1224 with an engagement surface 1226 that is contacted by the resilient members of the gripping member 1250 located in elongate member 310 when the fitment 1210 and the gripping member 1250 are engaged with each other. The engagement surface 1226 is angled or tapered so that the resilient members move outwardly and over the ridge in a manner similar to the embodiments described above. Once the resilient members of the gripping member 1250 pass over the ridge, the inwardly extending portions of the resilient members engage a ratchet surface 1228 on the connector 1222. The ratchet surface 1228 has numerous grooves formed therein that are engaged by the resilient members. The grooves make the rotation of the gripping member 1250 relative to connector 1222 more difficult, which reduces the likelihood of such rotation of the gripping member 1250.

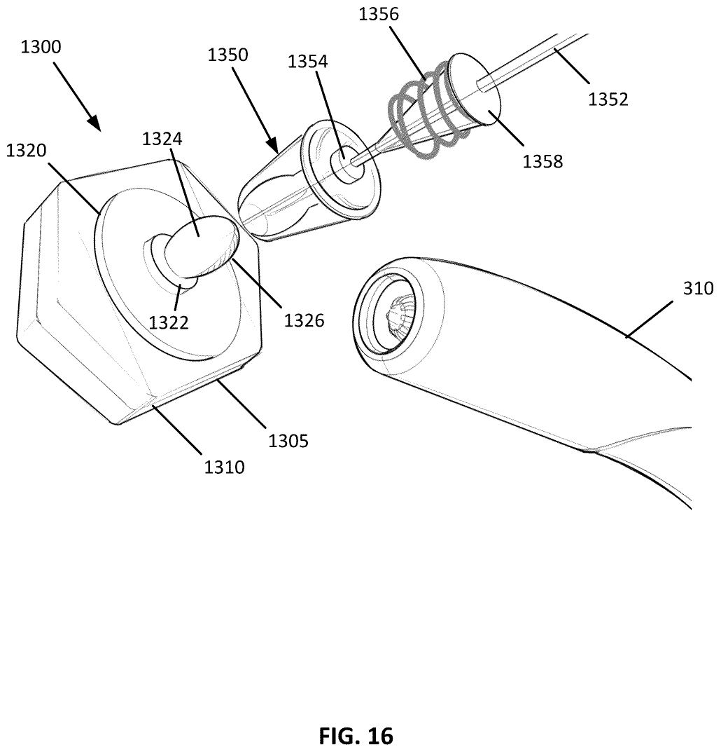

Turning to FIG. 16, some components of an alternative embodiment of a cleaning assembly according to the present disclosure are illustrated. In this embodiment, the cleaning assembly includes a disposable cleaning element 1300 that has a cleaning element 1305 mounted to a fitment 1310. The fitment 1310 has a base 1320 and a connector 1322 extending away from the base 1320. The connector 1322 has a coupling portion 1324 with an engagement surface 1326 that is contacted by the resilient members of the gripping member 1350 located in elongate member 310 when the fitment 1310 and the gripping member 1350 are engaged with each other. The engagement surface 1326 is curved and bubble-shaped so that the resilient members move outwardly and over a wider portion of the coupling portion 1324. In this embodiment, a push rod 1352 has a plunger head 1354, a spaced apart spring retainer plate 1358 and a biasing member 1356 located therebetween. As the push rod 1352 is moved toward the disposable cleaning element 1300, the plunger head 1354 engages the coupling portion 1324 and pushes the connector 1322 out of engagement from the resilient members of the gripping member 1350.

While this application has described the techniques presented herein in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Finally, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Similarly, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”. Finally, for the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

What is claimed is:

1. A cleaning assembly comprising:
an elongate member having a handle portion and a coupling portion;
a connector system supported by the elongate member, the connector system including a gripping member and a release mechanism, the gripping member including spaced apart resilient fingers, the release mechanism being actuatable by a user to move the resilient fingers of the gripping member from securing positions to releasing positions; and
a disposable cleaning implement mountable to the coupling portion of the elongate member via the connector system, the disposable cleaning implement including:
a cleaning member, and
a fitment coupled to the cleaning member, the fitment having:
a base; and
a connector extending from the base, the connector having spaced apart curved engagement surfaces, each of the curved engagement surfaces terminating in an outwardly extending ridge, each outwardly extending ridge defining a receiving area beneath the outwardly extending ridge, each receiving area being separated from any adjacent receiving area, wherein as the disposable cleaning implement is engaged with the elongate member, each of the resilient fingers moves along one of the curved engagement surfaces, moves over one of the outwardly extending ridges, and is positioned in one of the receiving areas.

2. The cleaning assembly of claim 1, wherein each of the curved engagement surfaces is a concave surface.

3. The cleaning assembly of claim 2, wherein the fitment has three curved engagement surfaces, and each of the curved engagement surfaces is bounded on its sides by curved walls.

4. The cleaning assembly of claim 3, wherein each curved engagement surface extends from a first side to a second side opposite the first side and extends from a first end to a second end opposite the first end.

5. The cleaning assembly of claim 4, wherein for each curved engagement surface, its second end terminates in one of the outwardly extending ridges.

6. The cleaning assembly of claim 3, wherein the curved walls of each of the curved engagement surfaces separate that curved engagement surface from adjacent curved engagement surfaces.

7. The cleaning assembly of claim 6, wherein each receiving area is defined by a first wall on a first side, a second wall on a second side, and one of the outwardly extending ridges.

8. The cleaning assembly of claim 7, wherein the disposable cleaning implement self-locates on the elongate member when each of the resilient fingers engages one of the receiving areas of the fitment, which prevents rotation of the disposable cleaning implement relative to the elongate member.

9. The cleaning assembly of claim 8, wherein each of the resilient fingers has as a distal end with an inwardly extending projecting portion with a convex configuration, and each inwardly extending projecting portion is inserted into one of the receiving areas of the fitment.

10. The cleaning assembly of claim 1, wherein the fitment has three curved engagement surfaces and three receiving areas, the gripping member has three resilient fingers, and each of the three resilient fingers engages one of the three receiving areas when the disposable cleaning implement is coupled to the elongate member.

11. A disposable cleaning implement that is mountable to an elongate member having a connector system, the connector system including a gripping mechanism and a release mechanism, the disposable cleaning implement comprising:
a cleaning member, and
a fitment coupled to the cleaning member, the fitment having:
a base; and
a connector extending from the base, the connector having a plurality of sloped engagement surfaces spaced apart from each other, each of the plurality of sloped engagement surfaces extending to an outwardly oriented ridge, each outwardly oriented ridge defining a receiving area beneath the outwardly oriented ridge, each receiving area being separated from adjacent receiving areas, wherein as the disposable cleaning implement is engaged with the gripping mechanism of the elongate member, resilient members of the gripping mechanism move along different ones of the plurality of sloped engagement surfaces, moves over one of the outwardly oriented ridges, and engages one of the receiving areas.

12. The disposable cleaning implement of claim 11, wherein each of the sloped engagement surfaces is a concave surface.

13. The disposable cleaning implement of claim 11, wherein the fitment has three sloped engagement surfaces, and each of the sloped engagement surfaces is bounded on its sides by curved walls.

14. The disposable cleaning implement of claim 11, wherein each sloped engagement surface extends from a first side to a second side opposite its first side, and extends from a first end to a second end opposite its first end, the second end terminating at outwardly oriented ridge associated with the sloped engagement surface.

15. The disposable cleaning implement of claim 11, wherein each receiving area is defined by a first wall on a first side, a second wall on a second side, and one of the outwardly oriented ridges.

16. The disposable cleaning implement of claim 11, wherein the disposable cleaning implement self-locates on the elongate member when each of the resilient members engages one of the receiving areas of the fitment, which prevents rotation of the disposable cleaning implement relative to the elongate member.

17. The disposable cleaning implement of claim 11, wherein the fitment has three sloped engagement surfaces and three receiving areas, and each of the three receiving areas is aligned with one of the three sloped engagement surfaces.

18. A disposable cleaning implement that is mountable to an elongate member having a connector system, the connector system including a gripping mechanism and a release mechanism, the gripping mechanism having resilient members that are spaced apart from each other, the disposable cleaning implement comprising:
a cleaning member, and
a fitment coupled to the cleaning member, the fitment having:
a base; and
a connector extending from the base, the connector having a longitudinal axis, the connector having sloped engagement surfaces, outwardly extending ridges, and receiving areas, each sloped engagement surface is spaced apart from the other sloped engagement surfaces, each sloped engagement surface extends from a first end located a first distance from the longitudinal axis to a second end located a second distance from the longitudinal axis, the second distance being greater than the first distance and being located at one of the outwardly extending ridges, each outwardly extending ridge being located between one of the sloped engagement surface and one of the receiving areas, each receiving area being spaced apart from the other receiving areas, wherein as the disposable cleaning implement is engaged with the gripping mechanism of the elongate member, each resilient member moves along one of the sloped engagement surfaces, moves over one of the outwardly extending ridges, and engages one of the receiving areas.

19. The disposable cleaning implement of claim 18, wherein each of the sloped engagement surfaces is a concave surface, and each receiving area is defined by a first wall on a first side, a second wall on a second side, and one of the outwardly extending ridges.

20. The disposable cleaning implement of claim 18, wherein the disposable cleaning implement self-locates on the elongate member when the resilient members engage the receiving areas of the fitment, which prevents rotation of the disposable cleaning implement relative to the elongate member.
